(19) United States
(12) Patent Application Publication
(10) Pub. No.: US 2008/0054152 A1
(43) Pub. Date: Mar. 6, 2008

(54) Series-type engine mount and method of manufacturing series-type engine mount

(75) Inventors: Hajime Maeno, Kasugai-shi (JP); Atsushi Muramatsu, Komaki-shi (JP)

Correspondence Address: OLIFF & BERRIDGE, PLC, P.O. BOX 320850, ALEXANDRIA, VA, 22320-4850, US

(73) Assignee: TOKAI RUBBER INDUSTRIES, LTD., Komaki-shi (JP)

(21) Appl. No.: 11/905,718

(22) Filed: Oct. 3, 2007

Related U.S. Application Data
(62) Division of application No. 11/006,769, filed on Dec. 8, 2004, now abandoned.

(30) Foreign Application Priority Data
Dec. 12, 2003 (JP) 2003-415767

(51) Int. Cl. B60K 5/12

(52) U.S. Cl. 248/562

(57) ABSTRACT

A series-type engine mount provided in a selectively combined arrangement (B-1), (B-2) or (B-3), with an mount body (A). (A) A fluid-filled mount body has an elastic body connecting a first and second mounting member; a pressure receiving chamber defined by the elastic body; an equilibrium chamber defined by a flexible layer; a first orifice passage connection the pressure receiving and equilibrium chambers; a medial chamber; a second orifice passage connecting the medial and equilibrium chambers; a pressure fluctuation transmitting mechanism; a pressure regulating rubber plate; an air chamber; and an air passage connected to the air chamber with a port. (B-1) The port is open to an atmosphere to expose the air chamber to atmosphere. (B-2) The port is connected alternatively to atmosphere and vacuum via a static pressure switching valve. (B-3) The port is cyclically switched between connection to atmosphere and vacuum via a dynamic pressure switching valve.

### INCORPORATED BY REFERENCE

This is a Division of application Ser. No. 11/006,769 filed Dec. 8, 2004. The entire disclosure of the prior application is hereby incorporated herein by reference in its entirety.

### BACKGROUND OF THE INVENTION

1. Field of the Invention

The present invention relates to a series-type engine mount of novel structure for use in automobiles of several marques. The series type engine mount is able to provide the mutually different vibration-damping characteristics required in automobiles of several different marques with high performance in each case. The present invention also relates to a method for manufacturing such a series-type engine mounting.

2. Description of the Related Art

As is well known, in order to achieve good ride comfort and stable steering in an automobile, it is necessary that the power unit be supported on the automobile body by means of a vibration-damping engine mount.

The vibration-damping characteristics required in an engine mount vary depending on factors such as the vibration produced by the power unit, the rigidity of the automobile body, the support characteristics of the power unit, the vibration characteristics of the suspension system, the desired ride feel and driving performance, predicted driving conditions and the like, as well as considerations such as parts costs depending on differences in grade established for different marques.

To date, in most cases, the different required characteristics for different marques and grades have been dealt with by designing and manufacturing parts separately for each kind of automobile (including not only different marques, but also different grades).

However, where design and production of engine mounts is carried out on an individual basis for different automobile marques, considerable expense and labor is entailed, and production costs are unavoidably higher due to the need for new press molds, rubber vulcanization molds, and other production equipment.

Additionally, since design and production of an engine mount must be carried out anew for each set of different required characteristics, during the new car development stage or a minor model change to a model, it is difficult to respond rapidly.

### SUMMARY OF THE INVENTION

It is therefore one object of this invention to provide a series-type engine mount of novel structure, able to provide, easily and with high performance in each case, the mutually different vibration-damping characteristics required in automobiles of several different marques.

It is another object of the invention to provide a method for manufacturing such a series-type engine mount.

The above and/or other objects may be attained according to at least one of the following aspects of the invention. The following preferred forms of the respective aspects of the invention may be adopted at any possible optional combinations. It is to be understood that the present invention is not limited to the following forms or combinations of these forms, but may otherwise be recognized based on the thought of the present invention that described in the whole specification and drawings or that may be recognized by those skilled in the art in the light of the disclosure in the whole specification and drawings.

First aspect of the invention relates to a series-type engine mount. A first mode of the first aspect of the invention provides a series-type engine mount provided in a selectively combined arrangement of the selected combination arrangement of (B-1), (B-2) or (B-3) hereinbelow, with the mount body disclosed in (A) hereinbelow, for use with multiple marques of automobile having different required vibration-damping characteristics.

(A) A fluid-filled mount body having (a) a first mounting member and a second mounting member arranged spaced apart from one another, and adapted to be attached respectively to components to be vibration-damped; (b) a rubber elastic body elastically connecting the first mounting member and the second mounting member; (c) a pressure receiving chamber having non-compressible fluid sealed therein, whose wall is constituted in part by said rubber elastic body, and that produces fluid pressure fluctuation during input of vibration; (d) an equilibrium chamber having non-compressible fluid sealed therein, and constituted in part by a flexible layer to permit changes in volume; (e) a first orifice passage whereby the pressure receiving chamber and the equilibrium chamber communicate with one another; (f) a medial chamber having non-compressible fluid sealed therein; (g) a second orifice passage tuned to a higher frequency band than does the first orifice passage, whereby the medial chamber and the equilibrium chamber communicate with one another; (h) a pressure fluctuation transmitting mechanism disposed between the pressure receiving chamber and the medial chamber for permitting a restricted pressure fluctuation transmission between the pressure receiving chamber and the medial chamber owing to restrictive displacement or deformation of a movable member thereof; (i) a pressure regulating rubber plate disposed so as to constitute part of the wall of the medial chamber, for regulating fluid pressure fluctuation in the medial chamber owing to an elastic deformation thereof; (j) a working air chamber formed on an opposite side of the pressure regulating rubber plate from the medial chamber, and (k) an air passage connected to the working air chamber and communicating with a port open to an outside.

(B-1) A first selected combination arrangement wherein the port is normally open to an atmosphere so that the working air is normally subjected to approximately atmospheric pressure.

(B-2) A second selected combination arrangement wherein the port is selectively connected alternatively to atmospheric pressure and a negative pressure source via a static pressure switching valve, whereby on the basis of switching action by the static pressure switching valve, pressure in the working air chamber can be statically modified between atmospheric pressure and negative pressure settings.

(B-3) A third selected combination arrangement wherein the port is cyclically switched between connection to atmospheric pressure and to a negative pressure source via a dynamic pressure-switching valve, whereby on the basis of switching action by the dynamic pressure-switching valve, pressure in the working air chamber can be dynamically modified.

In the series-type engine mount constructed according to this aspect of the invention, with the fluid-filled mount body of specific structure like (A) described above employed in combination with the alternatively selected combination arrangement of (B-1), (B-2) or (B-3) described above, it is possible to produce mutually different vibration-damping characteristics required of engine mounts for automobiles of different marques, by simply varying the supplemental combined arrangement while keeping the same mount body.

The engine mount vibration-damping characteristics achieved through combination with the first combined arrangement element (B-1), the engine mount vibration-damping characteristics achieved through combination with the second combined arrangement element (B-2), and the engine mount vibration-damping characteristics achieved through combination with the third combined arrangement element (B-3) each effectively assures vibration-damping performance against vibration of multiple or wide specific frequency bands required in automobile engine mounts. Thus, the series-type engine mount provided by the invention affords effective vibration damping required in automobile engine mounts, regardless of which of combined arrangement elements is provided.

Namely, simply through selective combination of the first, second or third combined arrangement element with the mount body, it is possible to modify the vibration-damping characteristics of the provided engine mount, so that even in the case where, for example, quick modifications to vibration-damping characteristics should be required during testing of an automobile, it will be possible to meet this end easily.

Described in detail, the first selected combination arrangement where the mount body is combined with combined arrangement element (B1) makes it possible, through the action of the pressure fluctuation transmission means and the pressure adjusting rubber plate, to appropriately set the transmission characteristics to the medial chamber of fluid pressure fluctuation produced in the pressure receiving chamber during vibration input as well as the pressure absorption characteristics of the pressure receiving chamber, and to thereby achieve effective vibration-damping performance of vibration of multiple or wide specific frequency bands. In particular, the first orifice passage and the second are tuned to mutually different frequency bands, whereby the damping effect based on resonance of fluid induced to flow through the first orifice passage and the damping effect based on resonance of fluid induced to flow through the second orifice passage combine to provide effective damping action of vibration of mutually different frequency bands. For vibration of a higher frequency band than the tuning frequency bands of the first and second orifice passages, pressure produced in the pressure receiving chamber is exerted on the medial chamber through the pressure fluctuation transmission mechanism, whereupon the pressure in the medial chamber is absorbed by means of elastic deformation of the pressure regulating rubber plate, and releases to the atmosphere through the working air chamber, so that good vibration-damping performance is achieved.

In an engine mount where the mount body is combined with second combined arrangement element (B2), with the port connected to the atmosphere and the working air chamber subjected to atmospheric pressure, there is effectively achieved vibration-damping action similar to that of the engine mount provided in combination with the first combined arrangement element (B1) described above. Additionally, by connecting the port to a negative pressure source and exerting static negative pressure on the working air chamber, the pressure regulating rubber plate can be subjected to negative pressure and subjected to constricting force by means of suction, as a result of which the change in volume of the medial chamber due to elastic displacement of the pressure regulating rubber plate can be suppressed, whereby it is possible to more advantageously ensure the flow volume of fluid induced to flow through the second orifice passage, and to improve vibration-damping performance based on resonance of fluid induced to flow through the second orifice passage.

In an engine mount where the mount body is combined with third combined arrangement element (B3), it is possible to exert dynamic air pressure fluctuation on the working air chamber through the port, and to cause the air pressure fluctuation of this working air chamber to act on the pressure receiving chamber via the medial chamber, whereby it becomes possible to actively adjust fluid pressure fluctuation in the medial chamber and pressure receiving chamber. Thus, by adjusting fluid pressure fluctuation in the pressure receiving chamber at a frequency and phase depending on the input vibration, for example, it is possible to reduce vibration by canceling it out, to bring the pressure of the pressure receiving chamber to approximately zero so as to produce low-dynamic spring characteristics, to produce dynamic fluid pressure fluctuation in the pressure receiving chamber to improve high attenuation characteristics, or to otherwise achieve dynamic vibration-damping performance, whereby it becomes possible to achieved further improvement in vibration-damping performance by utilizing such active vibration-damping effect.

According to this mode, the pressure fluctuation transmission mechanism may employ as a movable member thereof, for example, a rubber elastic film similar to the pressure regulating rubber plate and separating the pressure receiving chamber from the medial chamber, so that on the basis of elastic deformation of the rubber elastic film caused by differences in fluid pressure fluctuation in the pressure receiving chamber exerted on a first side of the rubber elastic film and fluid pressure fluctuation in the medial chamber exerted on a second side of the rubber elastic film, fluid pressure fluctuation may be transmitted from the pressure receiving chamber to the medial chamber. With such a rubber elastic film, it is also possible to limit transmission of fluid pressure fluctuation by providing a separate restraining member, such as a plate, for restricting the level of elastic deformation of the rubber elastic film, or by limiting the level of elastic deformation of based on the elastic properties of the rubber elastic film per se. Alternatively, the pressure fluctuation transmission mechanism could instead be constructed, for example, by disposing as a movable member thereof a moveable plate member of generally plate shape at a location between the pressure receiving chamber and the medial chamber, arranged in such a way that the level of displacement in the plate thickness direction is limited by a plate or other restraining member, and such that pressure is exerted on a first face of the moveable plate member and pressure is exerted on a second face of the moveable plate member.

Further, in this mode, it is possible to employ a negative pressure pump or the like as the negative pressure source for connection to the working air chamber. Preferably, the negative pressure generated by the air intake system in the automobile's internal combustion engine will be utilized. An accumulator or the like may be used in order to reduce or cancel out negative pressure fluctuation in the air intake system of the internal combustion engine.

In the first aspect of the invention relating to a series-type engine mount, the mount body may favorably have an arrangement such that: the first orifice passage is tuned to engine shakes or other low frequency and large amplitude vibration for exhibiting vibration damping effect with respect to the low frequency and large amplitude vibration on the basis of flow action of the fluid flowing through the first orifice passage; the pressure fluctuation transmitting mechanism is tuned to engine idling vibration or other medium frequency and medium amplitude vibration so that fluid pressure fluctuation excited in the pressure receiving chamber during input of the medium frequency and medium amplitude vibration is transmitted to the medial chamber, while the fluid pressure fluctuation excited in the pressure receiving chamber during input of the low frequency and large amplitude vibration is not transmitted to and not released to the medial chamber; the second orifice passage is tuned to the medium frequency and medium amplitude vibration for exhibiting vibration damping effect with respect to the medium frequency and medium amplitude vibration on the basis of flow action of the fluid flowing through the second orifice passage; and the pressure regulating rubber plate is tuned to the high frequency and small amplitude vibration so that fluid pressure fluctuation transmitted from the pressure receiving chamber to the medial chamber through the pressure fluctuation transmitting mechanism during input of high frequency and small amplitude vibration is absorbed due to elastic deformation of the pressure regulating rubber plate, while the fluid pressure fluctuation transmitted from the pressure receiving chamber to the medial chamber through the pressure fluctuation transmitting mechanism during input of medium frequency and medium amplitude vibration is not absorbed and not released from the medial chamber due to restriction of the elastic deformation of the pressure regulating rubber plate is restricted.

In the mount body of this specific arrangement, all of the first, second and third combined arrangement elements can advantageously realize an automobile engine mount that has effective vibration-damping performance against automobile engine mount vibration of the kind that is particularly necessary to damp, namely engine shakes, booming noises while running, and engine idling vibration.

Specifically, vibration-damping with respect to low frequency and large amplitude vibration is effectively achieved on the basis of resonance of fluid flowing through the first orifice passage, and vibration-damping with respect to medium frequency and medium amplitude vibration is effectively achieved on the basis of resonance of fluid flowing through the second orifice passage, while vibration-damping with respect to high frequency and small amplitude vibration is effectively achieved on the basis of elastic deformation of the pressure regulating rubber plate. Vibration-damping with respect to high frequency and small amplitude vibration may also utilize passive vibration-damping performance afforded by a low-dynamic spring constant produced by fluid pressure absorbing action based on elastic deformation of the pressure regulating rubber plate in a state of the air chamber being subjected to atmospheric pressure. Alternatively, by adopting the third combined arrangement element (B-3), it is possible to obtain active vibration-damping performance on the basis of elastic deformation due to vibration of the pressure regulating rubber plate caused by pressure fluctuation that correspond to vibration being exerted on the air chamber.

In the first aspect of the invention relating to a series-type engine mount, the mount body may favorably have an arrangement such that the second mounting member is of cylindrical tubular configuration, the first mounting member is situated on a side of one open end of the second mounting member with a spacing therebetween, the rubber elastic body is disposed between and elastically connects the first and second mounting member with the one open end of the second mounting member fluid-tightly closed by means of the rubber elastic body, an other open end of the second mounting member is fluid-tightly closed by the flexible layer, the partition member is supported by the second mounting member to be situated between the rubber elastic body and the flexible layer so that the pressure receiving chamber is defined between the partition member and the rubber elastic body while the equilibrium chamber is defined between the partition member and the flexible layer, the medial chamber is formed within the partition member, the working air chamber is formed between the medial chamber and the equilibrium chamber, and the pressure fluctuation transmission mechanism is disposed in a septum portion between the medial chamber and the working air chamber, with the septum portion between the medial chamber and the working air chamber being utilized as the pressure fluctuation transmission mechanism, while utilizing the partition member to form the first orifice passage and the second orifice passage.

In the mount body having such a specific arrangement, the pressure receiving chamber, the medial chamber and the equilibrium chamber are arranged within the tubular second mounting member in series in an axial direction of the second mounting member with excellent space utilization. Thus, where the mount body is combined with the first, second, or third combined arrangement element, the series-type engine mount of structure according to the present invention can be realized in a compact configuration overall.

The series-type engine mount of the structure according to the present invention, in combination with the aforementioned second combined arrangement element (B-2), favorably employs an arrangement wherein the static pressure switching valve changes operating positions thereof depending on whether the automobile is in a running state or idling state.

In this mode, during running of the automobile, atmospheric pressure can be exerted on the working air chamber, while negative pressure is exerted thereon when the car is stopped, whereby during running, fluid pressure fluctuation of the medial chamber from the pressure receiving chamber will be absorbed by elastic deformation of the pressure regulating rubber plate so that vibration-damping effect with respect to high frequency and small amplitude vibration such as booming noises while driving can be advantageously derived on the basis of low-dynamic spring constant on the one hand, while when the automobile is stopped, absorption by the pressure regulating rubber plate of fluid pressure fluctuation of the medial chamber from the pressure receiving chamber will be suppressed, so that an adequate level of flow of fluid caused to flow through the second orifice passage can be assured, so that on the basis of the flow action of the fluid, vibration-damping against idling vibration and other medium frequency and medium amplitude vibration can be advantageously achieved.

The series-type engine mount of the structure according to the present invention, in combination with the aforementioned third combined arrangement element (B-3), favorably employs an arrangement wherein the dynamic pressure switching valve is switched between connection to atmospheric pressure and to a negative pressure source in a cycle depending on the frequency of the vibration to be damped.

In this arrangement, air pressure fluctuation utilizing atmospheric pressure and negative pressure can be exerted on the working air chamber, and fluid pressure in the pressure receiving chamber and medial chamber adjusted actively or dynamically depending on the frequency of the vibration to be damped. Thus, active vibration-damping performance may be achieved for vibration of multiple or wide specific frequency.

Second aspect of the invention relates to a method of manufacturing a series-type engine mount. A method of manufacturing a series-type engine mount for automobiles of different marques for which different vibration-damping characteristics are required, the method comprising: (i) a mount body preparation step wherein a the mount body disclosed in (A) hereinbelow is manufactured and prepared; (ii) a combination selection step wherein any one of combined arrangements suitable for a required vibration-damping performance is selected from among (B-1), (B-2) and (B-3) hereinbelow; and (iii) a step of combining the mount body manufacture in the mount body preparation step with any selected combined arrangement selected from (B-1), (B-2) and (B-3) in the aforementioned combination selection step, in order to provide an engine mount as a final product.

(A) A fluid-filled mount body having (a) a first mounting member and a second mounting member arranged spaced apart from one another, and adapted to be attached respectively to components to be vibration-damped; (b) a rubber elastic body elastically connecting the first mounting member and the second mounting member; (c) a pressure receiving chamber having non-compressible fluid sealed therein, whose wall is constituted in part by said rubber elastic body, and that produces fluid pressure fluctuation during input of vibration; (d) an equilibrium chamber having non-compressible fluid sealed therein, and constituted in part by a flexible layer to permit changes in volume; (e) a first orifice passage whereby the pressure receiving chamber and the equilibrium chamber communicate with one another; (f) a medial chamber having non-compressible fluid sealed therein; (g) a second orifice passage tuned to a higher frequency band than does the first orifice passage, whereby the medial chamber and the equilibrium chamber communicate with one another; (h) a pressure fluctuation transmitting mechanism disposed between the pressure receiving chamber and the medial chamber for permitting a restricted pressure fluctuation transmission between the pressure receiving chamber and the medial chamber owing to restrictive displacement or deformation of a movable member thereof; (i) a pressure regulating rubber plate disposed so as to constitute part of the wall of the medial chamber, for regulating fluid pressure fluctuation in the medial chamber owing to an elastic deformation thereof; (j) a working air chamber formed on an opposite side of the pressure regulating rubber plate from the medial chamber, and (k) an air passage connected to the working air chamber and communicating with a port open to an outside.

(B-1) A first selected combination arrangement wherein the port is normally open to an atmosphere so that the working air is normally subjected to approximately atmospheric pressure.

(B-2) A second selected combination arrangement wherein the port is selectively connected alternatively to atmospheric pressure and a negative pressure source via a static pressure switching valve, whereby on the basis of switching action by the static pressure switching valve, pressure in the working air chamber can be statically modified between atmospheric pressure and negative pressure settings.

(B-3) A third selected combination arrangement wherein the port is cyclically switched between connection to atmospheric pressure and to a negative pressure source via a dynamic pressure switching valve, whereby on the basis of switching action by the dynamic pressure switching valve, pressure in the working air chamber can be dynamically modified.

According to the method of the invention, the mount body of specific structure like (A) described above is employed, and is combined with the alternatively selected combination arrangement of (B-1), (B-2) or (B-3) described above, whereby by simply varying the supplemental combined arrangement while keeping the same engine mount body, it is possible to produce mutually different vibration-damping characteristics required of engine mounts for automobiles of different marques. Thus, it is possible to advantageously and efficiently provide engine mounts with mutually different required characteristics, for installation in automobiles of a number of different marques. For instance, the present method permits a rapid response to a need of change in vibration-damping characteristics during test of an automobile.

As will be apparent from the description hereinabove, in either aspect of the invention relating to series-type engine mount or to a series-type engine mount manufacturing method, the use of the mount body of specific structure like that described above, and the selective use of the selected combination arrangement additionally installed in the mount body, which is selected from one of a total of three predetermined arrangements, makes it possible to readily provide in each case engine mounts with mutually different vibration-damping characteristics and production costs. Additionally, since the mount body of specific structure is employed, regardless of which selected combination arrangement is employed, it is possible to achieve excellent vibration-damping effect with respect to vibration of multiple or wide specific frequency bands which is required in automobile engine mounts, on the basis of flow action of fluid-filled, and to thereby efficiently provide engine mounts with amply high performance, with very high cost efficiency.

Thus, according to the present invention, engine mounts with mutually different required characteristics for installation in automobiles of different marques can be provided at excellent product cost, while meeting the high levels of vibration-damping characteristics required of each.

### BRIEF DESCRIPTION OF THE DRAWINGS

The forgoing and/or other objects features and advantages of the invention will become more apparent from the following description of a preferred embodiment with reference to the accompanying drawings in which like reference numerals designate like elements and wherein:

FIG. 1 is an elevational view in axial or vertical cross section of an automobile engine mount of construction according to a first embodiment of the invention where is provided a first selected combination arrangement, which is taken along line 1-1 of FIG. 2;

FIG. 2 is a cross sectional view taken along line 2-2 of FIG. 1;

FIG. 3 is a cross sectional view taken along line 3-3 of FIG. 2;

FIG. 4 is an elevational view in axial or vertical cross section of an automobile engine mount of construction according to the first embodiment of the invention where is provided a second selected combination arrangement, which corresponds to FIG. 1;

FIG. 5 is an elevational view in axial or vertical cross section of an automobile engine mount of construction according to the first embodiment of the invention where is provided a third selected combination arrangement, which corresponds to FIG. 1;

FIG. 6 is a schematic view showing a functional structure of the engine mount of FIG. 1;

FIG. 7 is a schematic view showing a functional structure of the engine mount of FIG. 1 for providing vibration-damping performance with respect to low frequency and large amplitude vibration;

FIG. 8 is a graph showing vibration damping characteristics of the engine mounts of FIGS. 1, 4 and 5 in terms of frequency characteristics of damping coefficient and absolute value of complex spring constant of the engine mounts;

FIG. 9 is a schematic view showing a functional structure of the engine mount of FIG. 1 for providing vibration-damping performance with respect to medium frequency and medium amplitude vibration;

FIG. 10 is a schematic view showing a functional structure of the engine mount of FIG. 1 for providing vibration-damping performance with respect to high frequency and small amplitude vibration;

FIG. 11 is a schematic view showing a functional structure of the engine mount of FIG. 4;

FIG. 12 is a schematic view showing a functional structure of the engine mount of FIG. 2 for providing vibration-damping performance with respect to medium frequency and medium amplitude vibration;

FIG. 13 is a schematic view showing a functional structure of the engine mount of FIG. 5; and

FIG. 14 is an elevational view in axial or vertical cross section of a mount body of another construction, which is adoptable in the present invention.

### DETAILED DESCRIPTION OF PREFERRED EMBODIMENTS

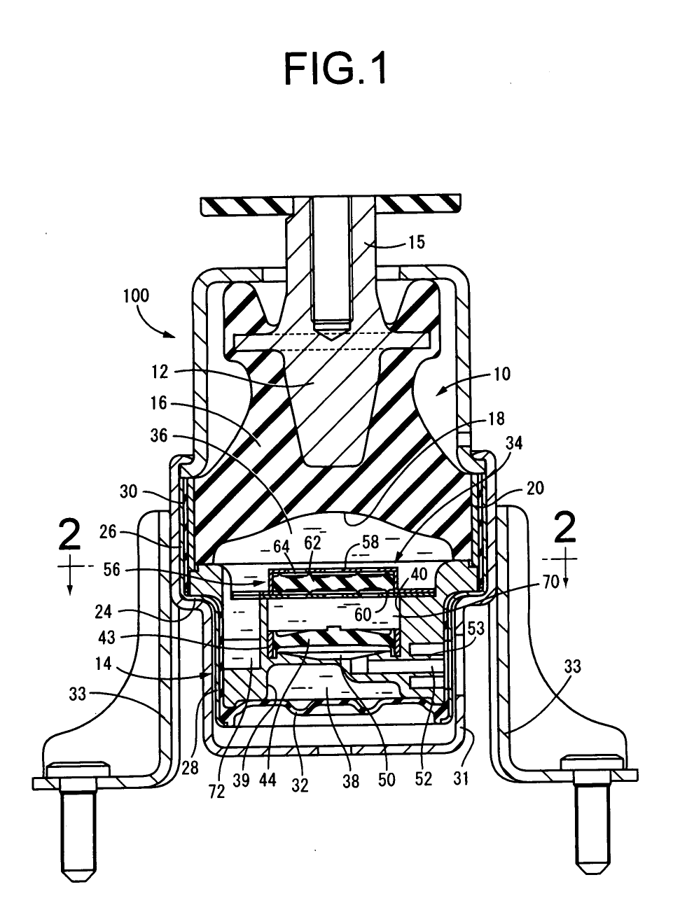

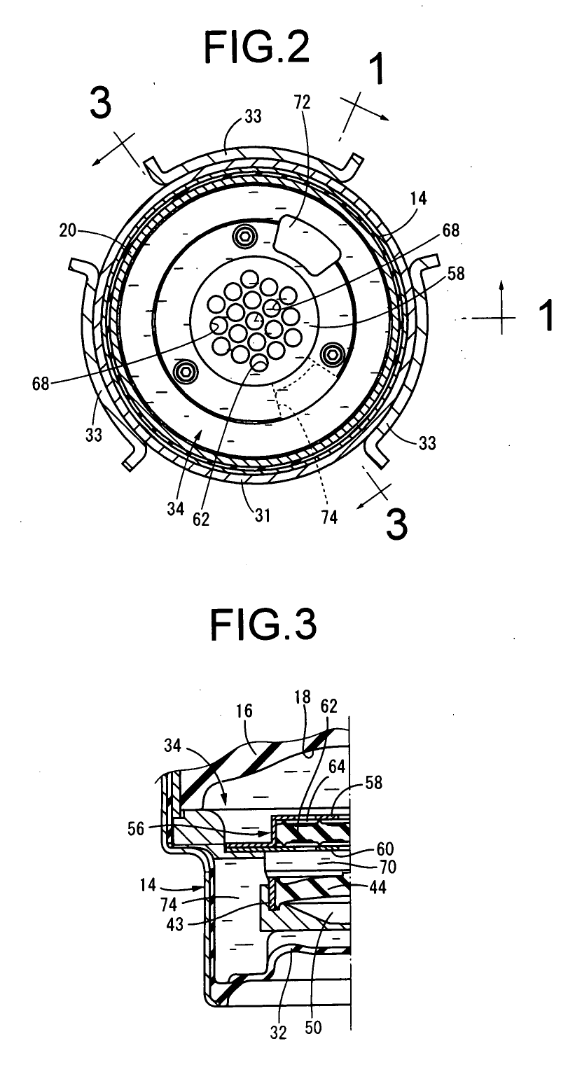

Referring first to FIGS. 1-3, shown is a mount body 10 constituting an automobile engine mount of constriction according to a first embodiment of the invention. The mount body 10 includes a first mounting member 12 of metal, a second mounting member 14 of metal, and an rubber elastic body 16 by which are elastically connected the first mounting member 12 and the second mounting member 14 disposed spaced away from each other. While it is not depicted in the drawings, the mount body 10 is installed on the automobile such that the first mounting member 12 is fixed to the power unit side of the automobile, while the second mounting member 14 is fixed to the body side of the automobile, whereby the mount body 10 fixedly supports the power unit on the body of the automobile in a vibration damping fashion, like conventional engine mounts. In the following description, the vertical direction shall be conformed to the vertical direction as seen in FIG. 1, which direction approximately corresponds to a primary input direction of vibration to be damped.

More specifically, the first mounting member 12 is of a generally inverted frustoconical configuration, and includes a nut portion 15 integrally formed at a large diameter end portion so as to protrude axially upwardly. By means of a mounting bolt (not shown) to be thread-engaged into a tapped hole formed through the nut portion 15, the first mounting member 12 is attached to the power unit side of the automobile.

To the first mounting member 12, the rubber elastic body 16 is bonded through vulcanization of a rubber material for forming the rubber elastic body 16 (hereinafter referred to simply as “vulcanization” where appropriate). The rubber elastic body 16 has a generally frustoconical configuration overall, with a relatively large diameter gradually increasing as its goes axially downwardly, and is formed with a recess 18 of inverted motor shape, which is open in a large diameter end face of the rubber elastic body 16. The first mounting member 12 is concentrically disposed with and bonded by vulcanization to the rubber elastic body 16 with the first mounting member 12 protruded axially downward into the rubber elastic body 16 from a small diameter end face of the rubber elastic body 16. A metallic sleeve 20 of large-diameter tubular configuration is superimposed and bonded by vulcanization onto an outer circumferential surface of the large diameter end portion of the rubber elastic body 16.

The second mounting member 14 is of a generally stepped tubular configuration having a relatively large diameter. The second mounting member 14 includes a shoulder portion 24 formed at an axially intermediate portion thereof, a large diameter portion 26 on the axially upper side and a small diameter portion 28 on the axially lower side. A thin sealing rubber layer 30 is bonded through vulcanization of a rubber material for forming thereof to inner circumferential surfaces of the large diameter portion 26 and the small diameter portion 28, thereby coating substantially entire area of the inner circumferential surfaces of the respective portions 26 and 28. On the side of the small diameter portion 28 of the second mounting member 14, there is provided a flexible layer in the form of a thin-disk shaped flexible diaphragm 32 made of a thin rubber layer, with its peripheral portion bonded through vulcanization of a rubber material for forming thereof to the opening peripheral edge of the second mounting member 14. Thus, the lower open end of the second mounting member 14 is closed with fluid tightness. In this embodiment, the flexible diaphragm 32 is integrally formed with the thin sealing rubber layer 30, and functions as a flexible layer.

The second mounting member 14 of construction as described above is externally fitted at its large diameter portion 26 onto the metallic sleeve 20, and secured thereon by pressing, drawing or other possible fixing process, whereby the second mounting member 14 is bonded onto the outer circumferential surface of the rubber elastic body 16. Thus, the first mounting member and the second mounting member are generally concentrically disposed with a common axis thereof extends along a primary vibration input direction in which vibration to be damped are applied to the mount body 10, and are spaced away from each other in the primary vibration input direction, and are elastically connected to each other by the rubber elastic body 16. With the large diameter portion 26 of the second mounting member 14 bonded to the rubber elastic body 16, the upper open end of the second mounting member 15 is closed with fluid-tightness.

The second mounting member 14 is sheathed into a generally tubular cup shaped bracket 31 having an inside diameter some what greater than an outside diameter of the second mounting member, and fixedly assembled therewith. A plurality of legs 33 are fixed by welding to an outer circumferential surface of the bracket 31, and extend axially downwardly. With the plurality of legs 33 fixed to the body of the automobile by means of bolts, the second mounting member 14 are fixedly mounted onto the body of the automobile. It should be noted that in order to permit an expansive deformation of the diaphragm 32, a sufficient volume of space is formed between the floor of the bracket 31 and the diaphragm 32, while being open to the atmosphere via a through hole formed through the floor of the bracket 31. To the upper open end of the bracket 31, a metallic tubular stop member is fixed by caulking so as to extend axially upwardly. This stop member is brought into abutting contact with the first mounting member via a rubber member bonded onto the upper end face of the large diameter portion of the first mounting member 12, whereby an amount of displacement between the first mounting member 12 and the second mounting member in the axial spaced away direction (i.e., in a so-called “rebound direction”) is restricted in a cushion wise manner.

A partition member 34 is housed within the small-diameter portion 28 of the second mounting member 14 such that the partition member 34 is disposed between the rubber elastic body 16 and the flexible diaphragm 32. This partition member 34 is a generally thick disk block member made of metal, synthetic resin material, or other suitable rigid materials. The partition member 34 is forcedly fitted into the small diameter portion 28 of the second mounting member 14, for example by press fitting the partition member 34 into the small diameter portion 28 or by drawing the small diameter portion 28 onto the partition member 34 disposed therein, whereby an outer circumferential surface of the partition member 34 is fluid-tightly fixed onto the small diameter portion 28 with the sealing rubber layer 30 compressed therebetween. With the partition member 34 assembled with the second mounting member 14 as described above, a region defined by and between the rubber elastic body 16 and the diaphragm 32 and fluid-tightly closed up from the external area is partitioned with fluid-tightness into two areas. Namely, on the axially upper side of the partition member 34 is formed a pressure receiving chamber in the form of a primary fluid chamber 36 partially defined by the rubber elastic body 16 and functioning as a pressure-receiving chamber, and on the axially lower side of the partition member 34 is formed an equilibrium chamber 38 partially defined by the flexible diaphragm 32 and having a volume valuable based on the deformation of the flexible diaphragm 32.

The primary fluid chamber 36 and the equilibrium chamber 38 are both filled with a non-compressible fluid such as water, alkylene glycol, polyalkylene glycol and silicone oil. For effective damping performance based on resonance of the fluid, which will be described in detail later, it is preferable to employ a low-viscosity fluid whose viscosity is not higher than 0.1 Pa·s. It should be noted that the partition member 34 includes a lower recess 39 open in a central portion of its axially lower end face, whereby a volume of the equilibrium chamber 38 is effectively obtained with the presence of the lower recess 39.

The partition member 34 further includes a central recess 40 open in a central portion of its axially upper end face. In this central recess 40, there is disposed a pressure regulating rubber plate in the form of a rubber elastic plate 44. The rubber elastic plate 44 is a thin-disk shaped member with given thickness and bonded at its peripheral portion to a fixing ring 43 disposed about thereof, through vulcanization of a rubber material for forming thereof. This fixing ring 43 is press fitted into the central recess 40, whereby the rubber elastic plate 44 is situated near the floor of the central recess 40, extending in its axis-perpendicular direction. With this arrangement, the central recess 40 is fluid-tightly partitioned at the portion near its bottom, to thereby form a working air chamber 50 defined by and between the rubber elastic layer 44 and the floor surface of the central recess 40, which is fluid tightly separated from the primary fluid chamber 36 and the equilibrium chamber 38.

An air passage 52 is formed into the partition member 34, such that one open end of the air passage 52 is open to the working air chamber 50, and the other open end of the air passage 52 is connected to a tubular port 53 open in the outer circumferential surface of the partition member 34. This port 53 is exposed to the external area through windows formed through the second mounting member 14 and the bracket 31. As will be described later, by means of combining a suitable selected combination arrangement with this port 53, an air pressure in the working air chamber may be adjustable from the external area through the air conduit 54 and the air passage 52.

On the upper face of the partition member 34, there is disposed a pressure fluctuation transmitting mechanism 56. This pressure fluctuation transmitting mechanism 56 includes an upper support plate 58, a lower support plate 60, and a movable plate member in the form of a movable rubber plate 62. More specifically, the thin upper support plate 58 having a hut-like configuration is superimposed on the thin lower support plate 60, whereby the lower open end of the upper support plate 58 is closed by means of the lower support plate 60, thereby providing a support housing having a restricted accommodation space 64 defined therein. The upper and lower support plates are both formed with a plurality of communication holes 68 perforated through their thickness at their central portions defining the restricted accommodation space 64.

The movable rubber plate 62 is housed within the restricted accommodation space 64 formed between the upper and lower support plates 58, 60. This movable rubber plate 62 has a thickness dimension smaller than an inside height dimension of the restricted accommodation space 64, and an outside diameter dimension smaller than an inside diameter dimension of the restricted accommodation space 64, so that the movable rubber plate 62 is housed within the restricted accommodation space 64 in an axially movable manner. An amount of the displacement of the movable rubber plate 62 in the axial or its thickness direction is limited within a given amount by means of abutting contact thereof against the upper and lower support plates 58, 60.

The pressure fluctuation transmitting mechanism 56 of construction as described above is superimposed onto the upper face of the partition member 34 such that mutually tightly laminated upper and lower support plates 58, 60 are bolted at their outer peripheral portions to the partition member 34. With this state, the opening of the central recess 40 is covered by the pressure fluctuation transmitting mechanism 56, while the restricted accommodation space 64 is situated axially above the opening of the central recess 40.

That is, the pressure fluctuation transmitting mechanism 56 constitute a part of the wall of the primary fluid chamber 36, and a medial chamber 70 is defined within the central recess 40 on the axially opposite side from the primary fluid chamber 36 with the pressure fluctuation transmitting mechanism 56 situated therebetween. More specifically, the medial chamber 70 is formed within the central recess 40 and defined by and between the pressure fluctuation transmitting mechanism 56 and the rubber elastic plate 44. The non-compressible fluid is also filled within the medial chamber 70. In this pressure fluctuation transmitting mechanism 56, fluid flows between the primary fluid chamber 36 and the medial chamber 70 through the communication holes 68 formed through the upper and lower support plates 58, 60, are permitted by means of displacement of the movable rubber plate 62 in the axial direction within the restricted accommodation space 64, thereby executing pressure fluctuation transmission between two chambers 36 and 70. With this regards, the amount of fluid pressure fluctuation to be transmitted may be restricted as a result of the above-described restriction of the displacement amount of the movable rubber plate 62 by means of abutting contact of the movable rubber plate 62 against the upper and lower support plate 58, 60.

The partition member 34 at least partially defines a first orifice passage 72 and the second orifice passage 74. For the first orifice passage 72, the partition member 34 is formed with a circumferential groove extending in its circumferential direction of a circumferential length slightly smaller than that of its circumference, while being open in its outer circumferential surface. The opening of this circumferential groove is fluid-tightly closed by the second mounting member 14, thereby providing the first orifice passage 72 that is held in fluid communication with the primary fluid chamber 36 at one end open in the upper face of the partition member 34, and held in fluid communication with the equilibrium chamber 38 at the other end open in the lower face of the partition member 34. Namely, the first orifice passage 72 permits a mutual fluid communication between the primary fluid chamber 36 and the equilibrium chamber 38.

For the second orifice passage 74, the partition member 34 is also formed with an axial groove open in its outer circumferential surface and extending in its axial direction from the axially medial portion to the lower edge portion. The opening of the axial groove is fluid-tightly closed by the second mounting member 14, thereby providing the second orifice passage 74 that is held in fluid communication with the medial chamber 70 at one end of radially inwardly extending tunnel shape open to the medial chamber 70, and held in fluid communication with the equilibrium chamber 38 at the other end open downward. Namely, the second orifice passage 74 permits a mutually fluid communication between the medial chamber 70 and the equilibrium chamber 38.

In the present embodiment, the first orifice passage 72 is tuned to a low frequency band at around 10 Hz corresponding to engine shakes or the like, thereby achieving excellent anti-vibration effect (high damping effect) on the basis of resonance of the fluid flowing through the first orifice passage 72.

The second orifice passage 74, on the other hand, is tuned to a medium frequency range at around 20-40 Hz corresponding to engine idling vibration or the like, thereby achieving excellent anti-vibration effect (vibration isolating effect through low dynamic spring constant) on the basis of resonance of the fluid flowing through the first orifice passage.

The tuning of the first and second orifice passages 72, 74 may be attained by suitably adjusting the length and cross sectional area of each passage while taking into account the wall spring stiffness of each of the primary, equilibrium and medial chambers 36, 38, 70 or the like, where meant by the “wall spring stiffness” is a characteristic value corresponding to an pressure fluctuation amount required to undergo deformation of the wall by unit volume. Generally, a frequency to which is tuned the first orifice passage 72 or the second orifice passage 74 may be recognized as a frequency at which a phase of the fluid pressure fluctuation of fluid flowing through the first orifice passage 72 or the second orifice passage 74 is changed and generate a substantially resonance state of the fluid.

When installing the mount body 10 having the structure described above, for use as an engine mount, either the first, second, or third selected combination arrangement will be selected for employment, depending on the required vibration-damping characteristics, product cost, and other considerations. The mount body 10 equipped with the employed selected combination arrangement will provide the desired engine mount.

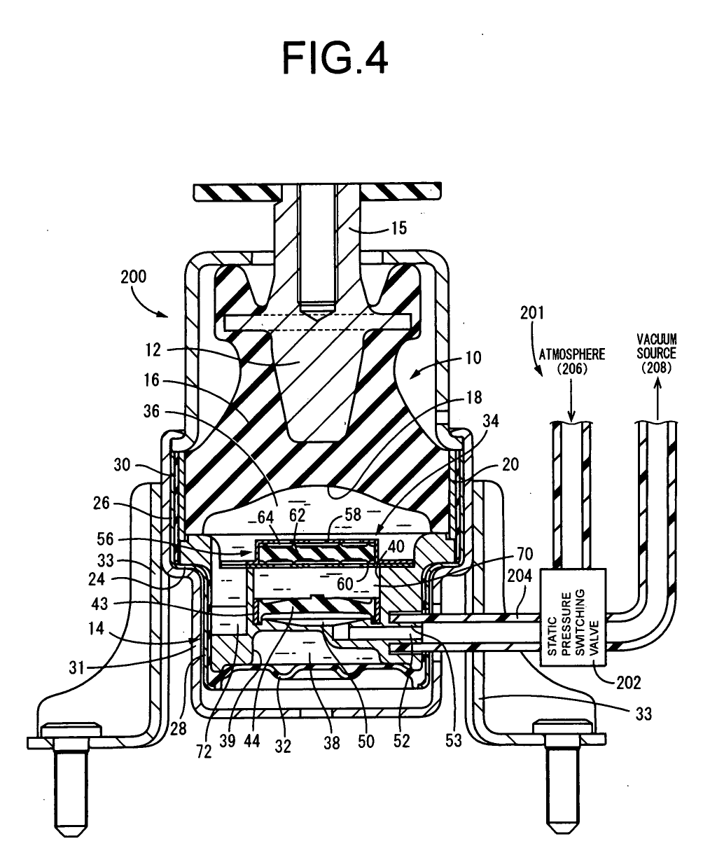

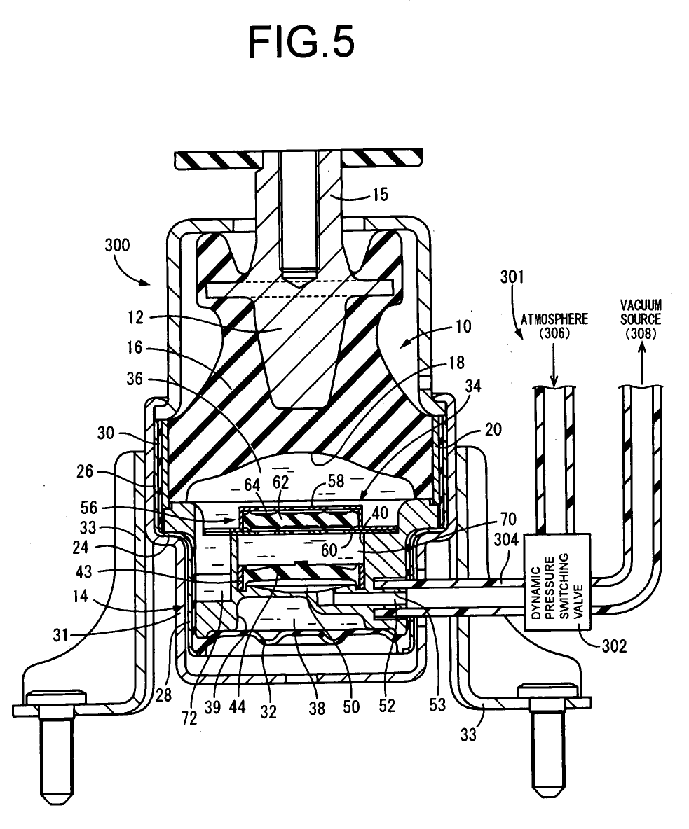

An engine mount 100 employing the first selected combination arrangement is depicted in FIG. 1, an engine mount 200 employing the second selected combination arrangement is depicted in FIG. 4, and an engine mount 300 employing the third selected combination arrangement is depicted in FIG. 5.

In the engine mount 100 shown in FIG. 1, the first selected combination arrangement employs an arrangement wherein the port 53 of the air passage 52 formed in the partition member 34 is normally open to the outside space. With this first selected combination arrangement, the working air chamber 52 is always exposed to atmospheric pressure through the port portion 53, and is adjusted to atmospheric pressure thereby.

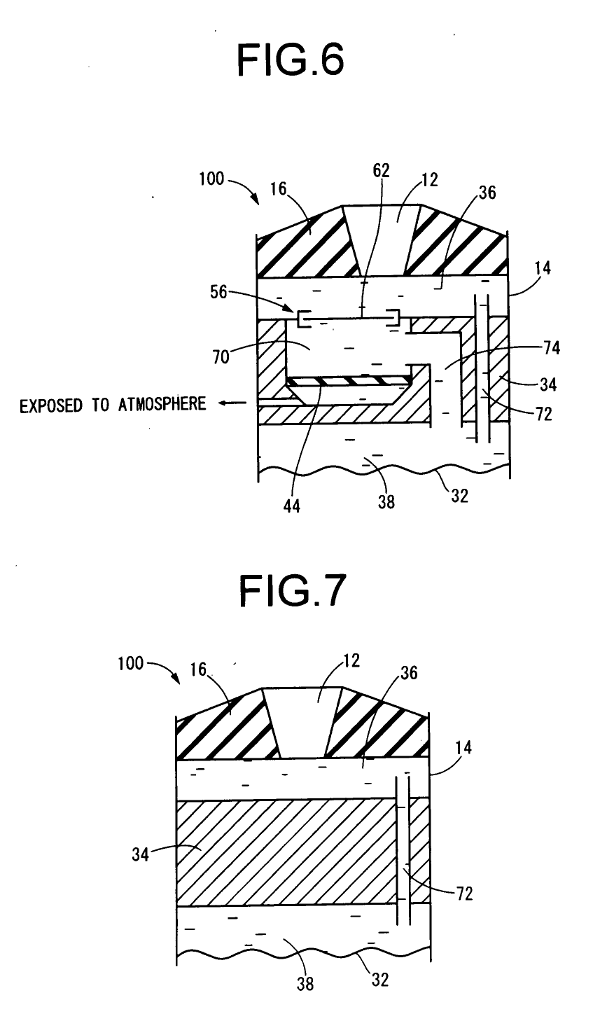

A schematic structure of the engine mount 100 employing this first selected combination arrangement is depicted in FIG. 6. Hereinafter, there will be described specific operations of the engine mount 100 for damping three kinds of vibration to be damped: (a) engine shakes of low frequency and large amplitude vibration; (b) engine idling vibration of medium frequency and medium amplitude vibration; and (c) booming noises of high frequency and small amplitude vibration, by way of example, and damping effects for these three kinds of vibration in detail.

(a) Vibration Damping Effect for Engine Shakes

When the engine mount 100 is subjected to input of engine shakes or other low frequency and large amplitude vibration, the primary fluid chamber 36 undergoes fluid pressure fluctuation having a considerably large amplitude. This huge fluid pressure fluctuation generates displacement of the movable rubber plate 62 of the pressure fluctuation transmitting mechanism 56. However, an amount of displacement of the movable rubber plate 62 is limited to a predetermined travel range so that the fluid pressure fluctuation induced in the primary fluid chamber 36 is not effectively absorbed by means of the limited displacement of the movable rubber plate 62. Thus, during input of the engine shakes or the like, the pressure fluctuation transmitting mechanism 56 is not able to actually operate, so that the huge fluid pressure fluctuation induced in the primary fluid chamber 36 is hardly transmitted to the medial chamber 70 via the pressure fluctuation transmitting mechanism 56.

That is, during input of low frequency and large amplitude vibration, the pressure fluctuation transmitting mechanism 56 and the medial chamber 70 are substantially held in non-functional condition, so that fluid flow through the second orifice passage 74 is hardly induced. FIG. 7 shows schematically a functional construction of the engine mount 100 in this state.

Described in detail, the engine mount 100 in the state for damping engine shakes as discussed above is functionally constructed such that a fluid communication between the primary fluid chamber 36 undergoing vibration input and the equilibrium chamber 38 of valuable volume is permitted through the first orifice passage 72 tuned to the low frequency range. With this state, relative fluid pressure fluctuation between the primary fluid chamber 36 and the equilibrium chamber 38 induced during input of vibration will cause a sufficient amount of flow of fluid through the first orifice passage 72 between the two chambers 36, 38, making it possible to exhibit advantageous anti-vibration effect (high damping effect) with respect to low frequency and large amplitude vibration. For the low-frequency and large amplitude vibration damping, the medial chamber 70 is hardly operated.

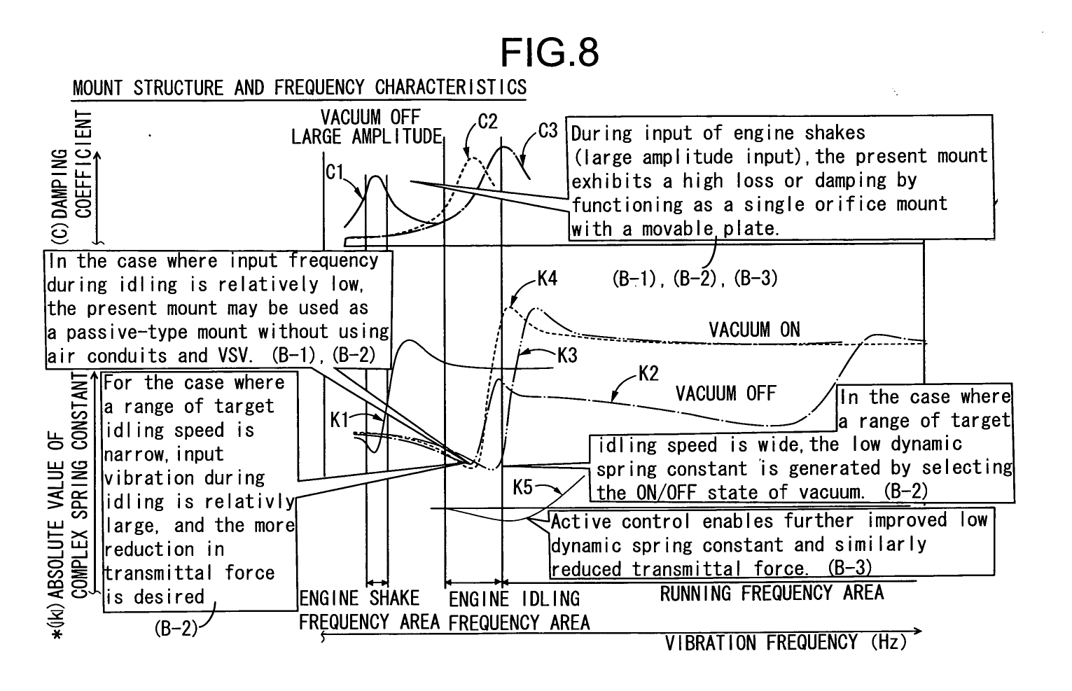

Vibration damping characteristics of the engine mount 100 with respect to low frequency and large amplitude vibration were actually measured in terms of absolute dynamic complex spring constant K1 and damping coefficient C1. Obtained measurements are demonstrated in the graph of FIG. 8. As is understood from the graph of FIG. 8, the engine mount 100 exhibits high damping coefficient C1 at a frequency range corresponding to the engine shakes.

(b) Vibration Damping Effect for Engine Idling Vibration

When the engine mount 100 is subjected to input of engine idling vibration or other medium frequency and medium amplitude vibration, the primary fluid chamber 36 undergoes fluid pressure fluctuation having a certain extent of amplitude. This certain extent of fluid pressure fluctuation generates suitable displacement of the movable rubber plate 62 of the pressure fluctuation transmitting mechanism 56 so that the fluid pressure fluctuation induced in the primary fluid chamber 36 is effectively transmitted to the medial chamber 70. Thus, during input of medium frequency and medium amplitude vibration, the pressure fluctuation transmitting mechanism 56 is effectively operated, so that the fluid pressure fluctuation induced in the primary fluid chamber 36 is transmitted to the medial chamber 70 via the pressure fluctuation transmitting mechanism 56, thereby exciting fluid pressure fluctuation in the medial chamber 70.

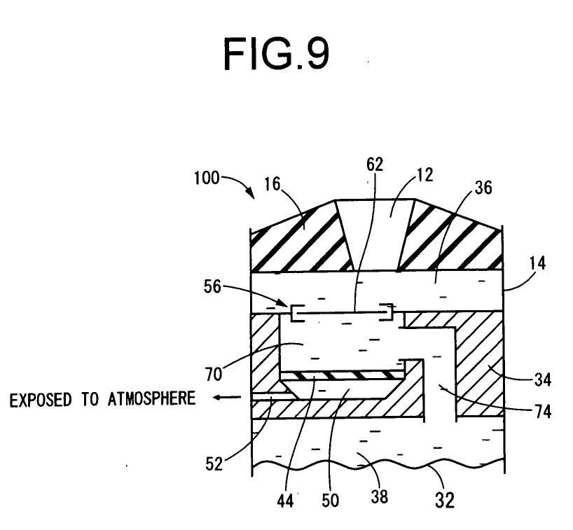

In the state where the engine mount 100 is subjected to input of medium frequency and medium amplitude vibration, since the first orifice passage 72 is tuned to the frequency range lower than that of input vibration, resistance to flow of the fluid through the first orifice passage will increase considerably due to anti resonance action of the fluid, whereby the first orifice passage 72 is held in substantially closed state. FIG. 9 shows schematically a functional construction of the engine mount 100 in this state.

Described in detail, the engine mount 100 in the state for damping engine idling vibration as discussed above is functionally constructed such that a fluid communication between the medial chamber 70 exciting effective fluid pressure fluctuation like in the primary fluid chamber 36 and the equilibrium chamber 38 of valuable volume is permitted through the second orifice passage 74 tuned to the medium frequency range. With this state, relative fluid pressure fluctuation between the medial chamber 70 together with the primary fluid chamber 36 and the equilibrium chamber 38 induced during input of vibration will cause a sufficient amount of flow of fluid through the second orifice passage 74 between the two chambers 36, 38, making it possible to exhibit advantageous anti-vibration effect (vibration isolating effect on the basis of low dynamic spring constant) with respect to medium frequency and medium amplitude vibration, such as engine idling vibration.

Vibration damping characteristics of the engine mount 100 with respect to medium frequency and medium amplitude vibration were actually measured in terms of absolute value of complex spring constant K2 and damping coefficient C2. Obtained measurements are demonstrated in the graph of FIG. 8. As is understood from the graph of FIG. 8, the engine mount 100 exhibits low dynamic spring constant and a resultant high vibration isolating effect at a frequency range corresponding to the engine idling vibration.

(c) Vibration Damping Effect for Booming Noises

When the engine mount 100 is subjected to input of booming noises or other high frequency and small amplitude vibration, the primary fluid chamber 36 undergoes fluid pressure fluctuation having small amplitude. This small amplitude fluid pressure fluctuation generates suitable displacement of the movable rubber plate 62 of the pressure fluctuation transmitting mechanism 56 so that the fluid pressure fluctuation induced in the primary fluid chamber 36 is effectively transmitted to the medial chamber 70. Thus, during input of medium frequency and medium amplitude vibration, the pressure fluctuation transmitting mechanism 56 is effectively operated, so that the fluid pressure fluctuation induced in the primary fluid chamber 36 is transmitted to the medial chamber 70 via the pressure fluctuation transmitting mechanism 56, and thus resealed.

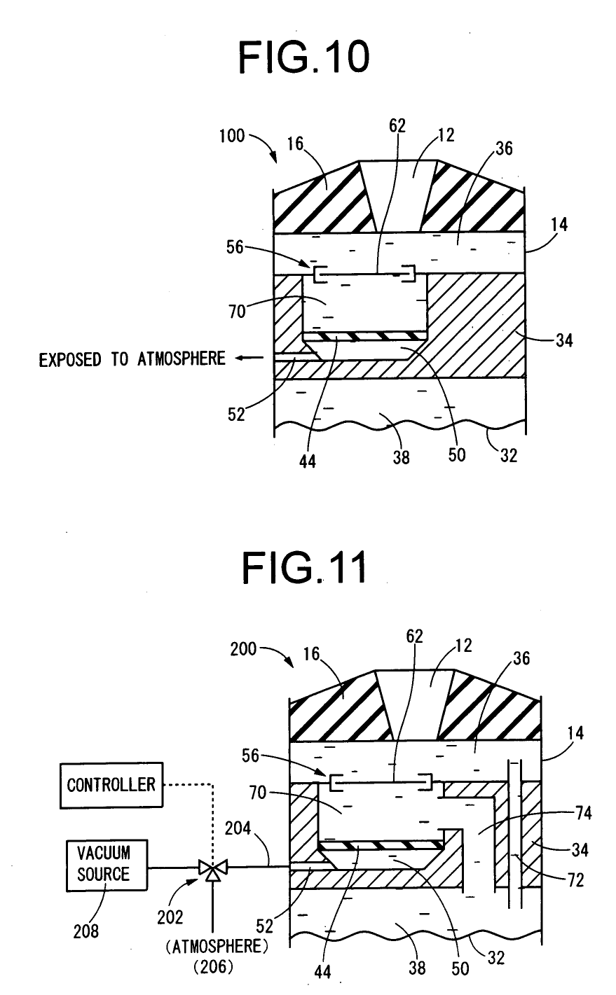

In the state where the engine mount 100 is subjected to input of high frequency and high amplitude vibration, since the first orifice passage 72 and the second orifice passage 74 are tuned to the frequency range lower than that of input vibration, resistance to flow of the fluid through the first and second orifice passages 72, 74 will increase considerably due to anti resonance action of the fluid, whereby the first and second orifice passages 72, 74 are held in substantially closed state. FIG. 10 shows schematically a functional construction of the engine mount 100 in this state.

Described in detail, the engine mount 100 in the state for damping booming noises as discussed above is functionally constructed such that the primary fluid chamber 36 and the medial chamber 70 to which the fluid pressure fluctuation of the primary fluid chamber 36 is released, are both substantially isolated or closed from the equilibrium chamber 38. However, the rubber elastic plate 44 partially constituting the wall of the medial chamber 70 at one face thereof, is opposed to the working air chamber 50 at the other face thereof, and thus exposed to the atmosphere. This arrangement permits a relatively readily elastic deformation of the rubber elastic plate 44. In particular, to the rubber elastic plate 44 is given a soft spring characteristics enough to sufficiently absorb fluid pressure fluctuation induced in the medial chamber 70 during input of booming noises or other high frequency and small amplitude vibration by its elastic deformation.

With this arrangement, the fluid pressure fluctuation induced in the primary fluid chamber 36 during input of vibration and transmitted to the medial chamber 70 is effectively absorbed by means of the elastic deformation of the rubber elastic plate 44 in the medial chamber 70. As a result, the engine mount 100 is able to avoid or moderate a phenomenon of high dynamic spring constant due to the substantial close of the first and second orifice passages 72, 74, thus exhibiting excellent vibration damping effect (vibration isolating effect on the basis of low spring constant) with respect to high frequency and small amplitude vibration.

Vibration damping characteristics for high frequency and small amplitude vibration of the engine mount 100 with the working air chamber 50 connected to the atmosphere 78 were actually measured in terms of absolute dynamic complex spring constant K2 and damping coefficient C2. Obtained measurements are demonstrated in the graph of FIG. 8. As is understood from the graph of FIG. 8, the engine mount 100 is able to attenuate or moderate phenomenon of high dynamic spring constant due to anti-resonance action of the fluid in the higher frequency band excess the tuning frequency band of the first and second orifice passages 72, 74.

In an engine mount 100 of above-described construction shown in FIG. 1, the mount body 10 having the specific structure described above is employed, thus achieving vibration-damping effect with respect to engine shake and booming noises, either of which can be a problem during running of an automobile, as well as engine idling vibration, which can be a problem during idling (not running) of the automobile. Since the engine mount 100 does not need additional installation of an actuator or external drive source when installed in an automobile, it enjoys particular advantages including ease to manufacture, a low manufacturing cost, and a compact size.

Turning now to the engine mount 200 shown in FIG. 4, which employs the mount body 10 of this embodiment as described above, in combination with the second selected combination arrangement where a static pressure switching device 201 is provided by way of the second selected combination arrangement. This static pressure switching device 201 enables adjustment of the pressure of the working air chamber 50. The static pressure switching device 201 comprises an air conduit 204 connected secured fitting from the outside, to the air passage 52 formed in the partition member 34 of the mount body 10. This air conduit 204 branches into two forks, with the one branch passage which branches out from the air passage 52 opening to the atmosphere 206, and the other branch passage being connected to a vacuum source 208. A static pressure switching valve 202 is disposed in the branched portion of the air conduit 204, and on the basis of switching operation by this static pressure switching valve 202, the working air chamber 50 is selectively connected to either the atmosphere 206 or the vacuum source 208.

In this embodiment, the switching operation of the static pressure switching valve 202 is controlled by a controller, not shown, on the basis of a sensor signal from a sensor that senses some condition of the automobile, for example, a speed sensor or an engine speed sensor.

A schematic structure of the engine mount 200 employing this first selected combination arrangement is depicted in FIG. 11. For the purpose of comparison with the engine mount 100 employing the first selected combination arrangement, there will be described specific operations of the engine mount 200 for damping three kinds of vibration to be damped: (a) engine shakes of low frequency and large amplitude vibration; (b) engine idling vibration of medium frequency and medium amplitude vibration; and (c) booming noises of high frequency and small amplitude vibration, by way of example, and damping effects for these three kinds of vibration in detail.

(a) Vibration Damping Effect for Engine Shakes

During input of engine shake or other low frequency and large amplitude vibration, since the pressure fluctuation transmission mechanism 56 and the medial chamber 70 are substantially non-functional, a schematic depiction of the functional structure of the engine mount 200 will be the same as that of the engine mount 100 employing the first selected combination arrangement, and as such will be as shown in FIG. 7. The vibration-damping characteristics will be as shown by the damping coefficient C1 in FIG. 8, with effective passive vibration-damping action of low frequency, large amplitude being similar to that achieved with the engine mount 100 described previously.

(b) Vibration Damping Effect for Engine Idling Vibration

During input of medium frequency and medium amplitude vibration such as engine idling vibration, the static pressure switching valve 202 is made to undergo switching operation so that the negative pressure is exerted on the working air chamber 50. That is, with the working air chamber 50 connected to the atmosphere 206 and placed thereby in a state affected by atmospheric pressure, the situation is substantially identical to the engine mount 100 employing the first selected combination arrangement, and the functional structure depicted in schematic form will be as shown in FIG. 9. On the other hand, with the working air chamber 50 connected to the vacuum source 208 so as to be affected by negative pressure, the negative pressure acts on the rubber elastic plate 44, causing the rubber elastic plate 44 to undergo tensile deformation.

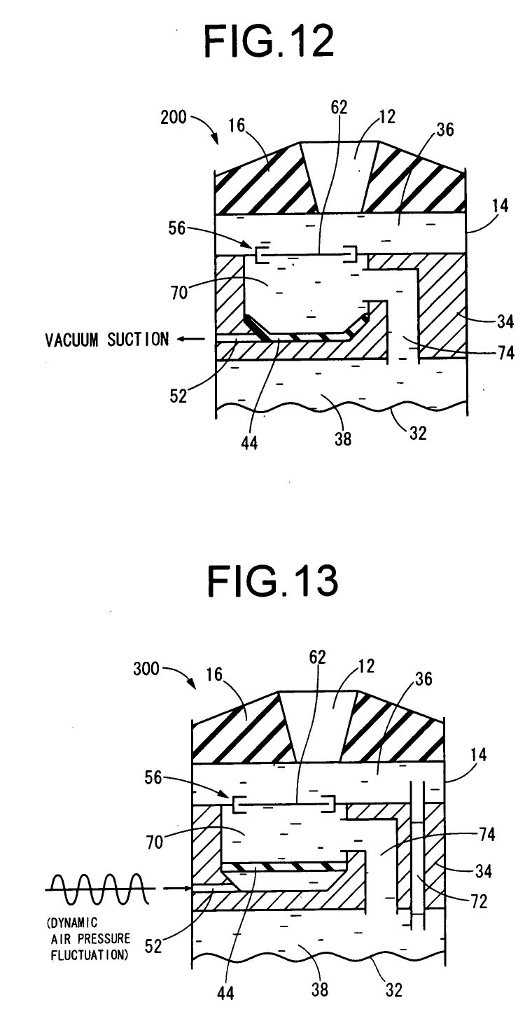

With this regards, the spring characteristics of the rubber elastic plate 44 constituting in part the wall of the medial chamber 70 will vary depending on whether the working air chamber 50 is connected to the atmosphere 206 or connected to the vacuum source 208. Specifically, with the working air chamber 50 connected to the atmosphere 206, as shown in FIG. 9, the rubber elastic plate 44 is placed in an non-restricted state and exhibits soft spring characteristics, whereas with the working air chamber 50 connected to the vacuum source 208, as shown in model form in FIG. 12, the rubber elastic plate 44 is deformed by negative pressure suction to the working air chamber 50 side, and under the strong suction the rubber elastic plate 44 becomes superimposed against the bottom face of the center recess 40 so as to become constrained and exhibit stiff spring rigidity. Thus, the medial chamber 70 wall spring rigidity will differ depending on whether the working air chamber 50 is connected to the atmosphere 206 or connected to the vacuum source 208. As a result, the tuning frequency of the second orifice passage 74 changes, thereby changing a frequency at which effective vibration-damping action is exhibited.

As will be apparent from the foregoing description, the rubber elastic plate 44 does not have spring characteristics as soft as those of the diaphragm 32, but instead has spring rigidity of a level such that pressure fluctuation of the medial chamber 70 occurring during input of medium frequency and medium amplitude vibration such as engine idling vibration cannot be absorbed on the basis of elastic deformation thereof, so that there can occur in the medial chamber 70 pressure fluctuation sufficient to induce fluid flow through the second orifice passage 74.

For instance, the working air chamber 50 is alternatively connected to the atmosphere 206 and the vacuum source 208, by means of switching operation of the switch valve 202, depending on whether the automobile is in a normal engine idling condition or a so-called first idling condition including a startup of the engine or and a running of an air conditioner. This makes it possible to alternatively tune with higher accuracy the second orifice passage 74 to different idling vibration having respective medium frequency ranges different from each other by a few or a few dozen of Hz, thereby permitting the engine mount 200 to exhibit further improved vibration damping effect.

Vibration damping characteristics of the engine mount 200 with respect to medium frequency and medium amplitude vibration were actually measured in terms of absolute value of complex spring constant K2 and damping coefficient C2 for the case where the working air chamber 50 is connected to the atmosphere 206, and in terms of absolute value of complex spring constant K3 and damping coefficient C3 for the case where the working air chamber 50 is connected to the vacuum source 208. Obtained measurements are demonstrated in the graph of FIG. 8. As is understood from the graph of FIG. 8, the engine mount 10 is capable of suitably adjusting a frequency of its low spring dynamic constant by alternatively connecting the working air chamber 50 to the atmosphere 206 and the vacuum source 208, within an idling frequency range, whereby the engine mount 200 is able to exhibit sophisticated vibration damping effect for medium frequency and medium amplitude vibration.

It should be noted that it is not an essential feature of the present invention to vary the tuning frequency of the second orifice passage 74 by changing operating position of the switch valve 76 depending on the driving conditions of the automobile (e.g. whether the air conditioner is On or Off). The principle of the present invention may be otherwise achieved, for example, such that the working air chamber 50 is always connected to the vacuum source 208 during input of engine idling vibration, provided an amount of fluctuation of engine idling vibration be relatively small, or the like, and the second orifice passage 74 is tuned so as to exhibit effective vibration damping effect with respect to the engine idling vibration. This arrangement was actually applied to the engine mount 10, and vibration damping characteristics of the engine mount 10 with respect to medium frequency and medium amplitude vibration were actually measured in terms of absolute value of complex spring constant K4. Obtained measurements are demonstrated in the graph of FIG. 8.

(c) Vibration Damping Effect for Booming Noises

During input of booming noises or other high frequency and small amplitude vibration, the working air chamber 50 is exposed to the atmosphere 206, whereby the pressure fluctuation transmission mechanism 56 can function effectively so that pressure of the primary fluid chamber 36 is transmitted to the medial chamber 70 and releases on the basis of elastic deformation of the rubber elastic plate 44. Thus, if the functional structure of the engine mount 200 in this state is depicted in model form, it will be the same as the engine mount 100 employing the first selected combination arrangement, as shown in FIG. 10. The vibration-damping characteristics will be in accordance with absolute value of complex spring constant K2 given in FIG. 8, and like the engine mount 100 described above, passive vibration-damping action effective against high frequency and small amplitude vibration will be achieved.

Accordingly, in the engine mount 200 shown in FIG. 4 employing the second selected combination arrangement, i.e., the static pressure switching device 201 as described above, vibration-damping characteristics can be modified more appropriately depending on automobile running conditions, as compared to the engine mount 100 employing the first selected combination arrangement described previously, whereby better vibration-damping characteristics of input vibration, and idling vibration in particular, may be achieved.

Turning next to the engine mount 300 shown in FIG. 5, which employs the mount body 10 of this embodiment as described above, in combination with the third selected combination arrangement, dynamic pressure switching device 301 is provided by way of the third selected combination arrangement, by means of which dynamic pressure switching device 301 the pressure of the working air chamber 50 is actively or dynamically controllable depending on input vibration. The dynamic pressure switching device 301 comprises an air conduit 304 connected secured fitting from the outside, to the air passage 52 formed in the partition member 34 of the mount body 10. This air conduit 304 branches into two forks, with the one branch passage which branches out from the air passage 52 opening to the atmosphere 306, and the other branch passage being connected to a vacuum source 308. A dynamic pressure switching valve 302 is disposed in the branched portion of the air conduit 304, and on the basis of switching operation by this dynamic pressure switching valve 302, the working air chamber 50 is selectively connected to either the atmosphere 306 or the negative pressure source 308.

In this embodiment, the switching operation of the dynamic pressure switching valve 302 is controlled by a controller, not shown, with reference, for example, to the ignition pulse signal of the internal combustion engine that constitutes the automobile engine, the operation taking place at frequency and appropriate phase depending on the ignition timing.

A simplified arrangement of the engine mount 300 employing this third selected combination arrangement is depicted in schematic form in FIG. 13. That is, the engine mount 300 employing the third selected combination arrangement may be achieved by employing the dynamic pressure switching valve 303 in place of the static pressure switching valve 202 in FIG. 11 which depicts the second selected combination arrangement in schematic form.

In operation, the dynamic pressure switching valve 303 performs its switching operation at frequency and phase depending on the frequency and phase of the vibration needing to be damped, for example, idling vibration while the vehicle is in idling condition, or booming noises while running. This creates oscillation of the rubber elastic plate 44, whereby the working air chamber 50 formed to the back of the medial chamber 70 is subjected to a dynamic air pressure fluctuation from the outside. As noted, this air pressure fluctuation can be exerted by means of generating a control signal for the dynamic pressure switching valve 302 by means of a control device using control vibration of phase matching the vibration to be damped such as an ignition pulse, and switching the dynamic pressure switching valve 302 at high speed to alternately switch the working air chamber 50 between connection to the atmosphere 306 and the vacuum source 308. Like in the engine mount 200 employing the second selected combination arrangement, the vacuum source 308 may be composed of a negative pressure pump, or the negative pressure generated by the air intake system in the automobile's internal combustion engine, for example. The negative pressure may be stored by an accumulator or the like for use.

In this embodiment, the air pressure fluctuation has a frequency and phase corresponding to those of vibration to be damped. This air pressure fluctuation corresponding to vibration to be damped is exerted on the working air chamber 50, whereby the pressure fluctuation of the working air chamber 50 positively and actively induces elastic deformation and vibrating deformation of the rubber elastic plate 44. By means of this, the pressure of the medial chamber 70 can be controlled actively, and the pressure of this medial chamber 70 can be exerted on the primary fluid chamber 36 via the pressure fluctuation transmission mechanism 56, for example. Thus, the pressure of the primary fluid chamber 36 can be actively and dynamically controlled.

Accordingly, the engine mount 300 of this embodiment is able to produce active vibration-damping action, and by canceling out and reducing pressure fluctuation of the primary fluid chamber 36 due to input vibration, for example as shown by the absolute value of complex spring constant K5 achieved with active control in FIG. 8. Namely, it is possible to achieve so-called spring zero control or the like. That is, the engine mounts 100, 200 employing the aforementioned first and second selected combination arrangements each exhibit passive vibration-damping action. In particular, while the engine mount 200 employing the second selected combination arrangement is provided with the controller and the static switching valve 202 that together with atmosphere 206 and the vacuum source 208 constitute static pressure switching device, this is simply for the purpose of adjusting static pressure level of the working air chamber 50 and as such constitutes passive switching device. On the other hand, the engine mount 300 of this embodiment is equipped with active control means wherein the control unit and the dynamic switching valve 302 together with atmosphere 306 and the vacuum source 208 make up dynamic pressure switching device, whereby a superior level of vibration-damping action may be achieved.

While the presently preferred embodiment of this invention has been described in detail for illustrative purpose only, it is to be understood that the present invention is not limited to the details of the illustrated embodiment.

In the illustrated embodiments, the pressure fluctuation transmitting mechanism is composed of the movable plate member in the form of the movable rubber plate 62 whose amount of displacement is restricted, and the movable rubber plate 62 is substantially freely displaceable in its thickness direction within the limited stroke range. Instead of the movable rubber plate 62, it is possible to employ a rubber elastic layer fixedly supported by the partition member 34 or the like at its part, and undergo elastic deformation to permit pressure transmission between the primary fluid chamber 36 and the medial chamber 70.

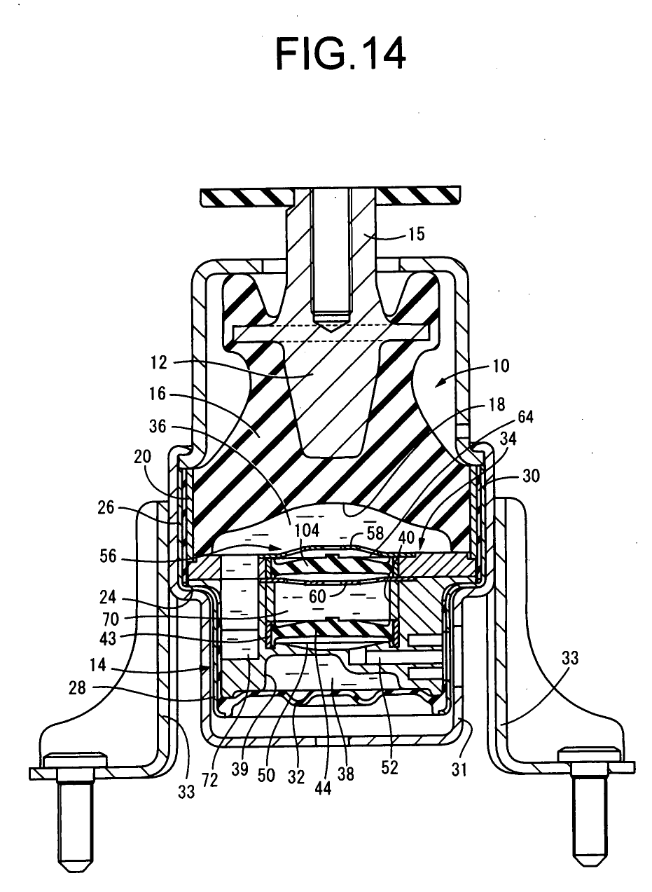

As one specific example, FIG. 14 illustrate the mount body 10 having a rubber elastic layer instead of the movable rubber plate 62. For the sake of facility of interpretation, the same reference numerals as used in the first embodiment will be used in this embodiment to identify the structurally or functionally corresponding components. This mount body 10 adopts a rubber elastic layer 104 of disk-like shape. This rubber elastic layer 104 is bonded at its peripheral portion to a fixing ring 105 through vulcanization of a rubber material for forming thereof. The fixing ring 105 is press fitted into the central recess 40 of the partition member 34 so that the rubber elastic layer 104 is fixedly bonded at its peripheral portion to the open end portion of the central recess 40. This arrangement permits transmission of fluid pressure fluctuation between the primary fluid chamber 36 and the medial chamber 70 based on elastic deformation of the central portion of the rubber elastic layer 104 caused by difference between both fluid pressures in both chambers 36, 70 exerted on opposite faces of the rubber elastic layer 104.

The rubber elastic layer 104 may be adapted to restrict pressure transmission amount between the primary fluid chamber 36 and the medial chamber 70 by limiting an amount of its elastic deformation per se. Alternatively, the rubber elastic layer 104 may be further accurately restricted in an amount of its elastic deformation by boding a canvas or the like thereto. In the mount body 10 shown in FIG. 14, the upper and lower support plates 58, 60 are disposed on the opposite sides of the rubber elastic layer 104 with a given axial spacing therebetween, so that the rubber elastic layer 104 is brought into abutting contact with the upper and lower support plates 58, 60, thereby restricting an amount of elastic deformation of the rubber elastic layer 104.

The rubber elastic layer 104 employed in the present embodiment is similar to the movable rubber plate 62 in structure, making it easy to manufacture the same. Preferably, the upper and lower support plates 58, 60 are provided for limiting elastic deformation of the rubber elastic layer 104, while the rubber elastic layer 104 is made more readily to deformation or small in dynamic spring constant than the movable rubber plate 62, by suitably adjusting rubber materials or the like. With this arrangement, when subjected to medium frequency and medium amplitude vibration, fluid pressure fluctuation generated in the primary fluid chamber 36 is effectively exerted on the medial chamber 70 via the rubber elastic layer 104, even if the working air chamber 50 is exposed to the atmosphere, and fluid pressure fluctuation generated in the medial chamber 70 is not absorbed by the rubber elastic layer 104, but effectively excited owing to wall spring stiffness of the rubber elastic layer 104. Thus, a sufficient amount of fluid flow through the second orifice passage 74 will be obtained, so that the engine mount 104 is able to enjoy vibration damping effect owing to the second orifice passage 74.

It should be appreciated that the present invention is not limited to the illustrated embodiments, in terms of structures of the first and second orifice passages 72, 74, tuning frequencies of these orifice passages, structures of the pressure fluctuation transmitting mechanism, structures of the rubber elastic plate 44 and the rubber elastic layer 104 for limiting pressure transmitting capacity, and the amount of restriction thereof, and specific structure of these pressure regulating rubber plates. These specific features may be suitably variable depending on required vibration damping performance or the size of the mount.

While the present invention as applied to automotive engine mounts has been described in the illustrated embodiments, the present invention is equally applicable to various other vibration damping devices for use in various kinds of vibrative members requiring vibration damping effect for a plurality of frequency ranges or over a wide frequency range.

The first selected combination arrangement, second selected combination arrangement, and third selected combination arrangement in the embodiments hereinabove may prepared so as to be pre-assemblable. It is not necessary that engine mounts of each combination arrangement among engine mounts assembled with all possible combination arrangements be actually employed in automobiles. Namely, the invention is effective even in instances where some combination arrangements are not actually used. Engine mounts in such instances will of course fall within the scope of the invention, insofar as the advantages of the invention in terms of ensuring design freedom and expandability are achieved.

It is also to be understood that the present invention may be embodied with various other changes, modifications and improvements, which may occur to those skilled in the art, without departing from the spirit and scope of the invention defined in the following claims.

What is claimed is:

1. An engine mount providing set comprising: a fluid-filled mount body defined in (A) below, and selective combination arrangements (B-1), (B-2) and (B-3) hereinbelow, for use with multiple marques of automobiles having different required vibration-damping characteristics;
(A) a fluid-filled mount body having (a) a first mounting member and a second mounting member arranged spaced apart from one another, and adapted to be attached respectively to components to be vibration-damped; (b) a rubber elastic body elastically connecting the first mounting member and the second mounting member; (c) a pressure receiving chamber having non-compressible fluid sealed therein, whose wall is constituted in part by said rubber elastic body, and that produces pressure fluctuation during input of vibration; (d) an equilibrium chamber having non-compressible fluid sealed therein, and constituted in part by a flexible layer to permit changes in volume; (e) a first orifice passage whereby the pressure receiving chamber and the equilibrium chamber communicate with one another; (f) a medial chamber having non-compressible fluid sealed therein; (g) a second orifice passage tuned to a higher frequency band than does the first orifice passage, whereby the medial chamber and the equilibrium chamber communicate with one another; (h) a pressure fluctuation transmitting mechanism disposed between the pressure receiving chamber and the medial chamber for permitting a restricted pressure fluctuation transmission between the pressure receiving chamber and the medial chamber owing to restrictive displacement or deformation of a movable member thereof; (i) a pressure regulating rubber plate disposed so as to constitute part of the wall of the medial chamber, for regulating fluid pressure fluctuation in the medial chamber owing to an elastic deformation thereof; (j) a working air chamber formed on an opposite side of the pressure regulating rubber plate from the medial chamber, and (k) an air passage connected to the working air chamber and communicating with a port open to an outside;
(B-1) a first arrangement wherein the port is normally open to an atmosphere so that the working air is normally subjected to approximately atmospheric pressure;
(B-2) a second arrangement wherein the port is selectively connected alternatively to atmospheric pressure and a negative pressure source via a static pressure switching valve, whereby on the basis of switching action by the static pressure switching valve, pressure in the working air chamber can be statically modified between atmospheric pressure and negative pressure settings;
(B-3) a third arrangement wherein the port is cyclically switched between connection to atmospheric pressure and to a negative pressure source via a dynamic pressure switching valve, whereby on the basis of switching action by the dynamic pressure switching valve, pressure in the working air chamber can be dynamically modified.

2. The engine mount providing set according to claim 1, wherein
the mount body has an arrangement such that: the first orifice passage is tuned to engine shakes or other low frequency and large amplitude vibration for exhibiting vibration damping effect with respect to the low frequency and large amplitude vibration on the basis of flow action of the fluid flowing through the first orifice passage;
the pressure fluctuation transmitting mechanism is tuned to engine idling vibration or other medium frequency and medium amplitude vibration so that fluid pressure fluctuation excited in the pressure receiving chamber during input of the medium frequency and medium amplitude vibration is transmitted to the medial chamber, while the fluid pressure fluctuation excited in the pressure receiving chamber during input of the low frequency and large amplitude vibration is not transmitted to and not released to the medial chamber;
the second orifice passage is tuned to the medium frequency and medium amplitude vibration for exhibiting vibration damping effect with respect to the medium frequency and medium amplitude vibration on the basis of flow action of the fluid flowing through the second orifice passage; and
the pressure regulating rubber plate is tuned to the high frequency and small amplitude vibration so that fluid pressure fluctuation transmitted from the pressure receiving chamber to the medial chamber through the pressure fluctuation transmitting mechanism during input of high frequency and small amplitude vibration is absorbed due to elastic deformation of the pressure regulating rubber plate, while the fluid pressure fluctuation transmitted from the pressure receiving chamber to the medial chamber through the pressure fluctuation transmitting mechanism during input of medium frequency and medium amplitude vibration is not absorbed and not released from the medial chamber due to restriction of the elastic deformation of the pressure regulating rubber plate is restricted.

3. The engine mount providing set according to claim 1, wherein
the second mounting member is of cylindrical tubular configuration;
the first mounting member is situated on a side of one open end of the second mounting member with a spacing therebetween;
the rubber elastic body is disposed between and elastically connects the first and second mounting member with the one open end of the second mounting member fluid-tightly closed by means of the rubber elastic body;
an other open end of the second mounting member is fluid-tightly closed by the flexible layer;
a partition member is supported by the second mounting member to be situated between the rubber elastic body and the flexible layer so that the pressure receiving chamber is defined between the partition member and the rubber elastic body while the equilibrium chamber is defined between the partition member and the flexible layer;
the medial chamber is formed within the partition member; and
the working air chamber is formed between the medial chamber and the equilibrium chamber.

4. The engine mount providing set according to claim 1, wherein in the combination with the second arrangement (B-2), the static pressure switching valve changes operating positions thereof depending on whether the automobile is in a running state or idling state.

5. The engine mount providing set according to claim 1, wherein in combination with the third arrangement (B-3), the dynamic pressure switching valve is switched between connection to atmospheric pressure and to a negative pressure source in a cycle depending on the frequency of the vibration to be damped.

6. The engine mount providing set according to claim 1, wherein the negative pressure source is provided by utilizing negative pressure generated by an air intake system in an automobile's internal combustion engine.

7. A method of manufacturing an engine mount that is selectively adjustable to have different vibration damping characteristics for automobiles of different marques for which different vibration-damping characteristics are required, the method comprising:
(i) preparing a mount body defined in (A) hereinbelow;
(ii) preparing arrangements (B-1), (B-2) and (B-3) hereinbelow, which are suitable for a required vibration-damping performance; and
(iii) combining the mount body defined in (A) with one of arrangements (B-1), (B-2) and (B-3), in order to provide an engine mount as a final product;
(A) a fluid-filled mount body having (a) a first mounting member and a second mounting member arranged spaced apart from one another, and adapted to be attached respectively to components to be vibration-damped; (b) a rubber elastic body elastically connecting the first mounting member and the second mounting member; (c) a pressure receiving chamber having non-compressible fluid sealed therein, whose wall is constituted in part by said rubber elastic body, and that produces fluid pressure fluctuation during input of vibration; (d) an equilibrium chamber having non-compressible fluid sealed therein, and constituted in part by a flexible layer to permit changes in volume; (e) a first orifice passage whereby the pressure receiving chamber and the equilibrium chamber communicate with one another; (f) a medial chamber having non-compressible fluid sealed therein; (g) a second orifice passage tuned to a higher frequency band than does the first orifice passage, whereby the medial chamber and the equilibrium chamber communicate with one another; (h) a pressure fluctuation transmitting mechanism disposed between the pressure receiving chamber and the medial chamber for permitting a restricted pressure fluctuation transmission between the pressure receiving chamber and the medial chamber owing to restrictive displacement or deformation of a movable member thereof; (i) a pressure regulating rubber plate disposed so as to constitute part of the wall of the medial chamber, for regulating fluid pressure fluctuation in the medial chamber owing to an elastic deformation thereof; (j) a working air chamber formed on an opposite side of the pressure regulating rubber plate from the medial chamber, and (k) an air passage connected to the working air chamber and communicating with a port open to an outside;
(B-1) a first arrangement wherein the port is normally open to an atmosphere so that the working air is normally subjected to approximately atmospheric pressure;
(B-2) a second arrangement wherein the port is selectively connected alternatively to atmospheric pressure and a negative pressure source via a static pressure switching valve, whereby on the basis of switching action by the static pressure switching valve, pressure in the working air chamber can be statically modified between atmospheric pressure and negative pressure settings;
(B-3) a third arrangement wherein the port is cyclically switched between connection to atmospheric pressure and to a negative pressure source via a dynamic pressure switching valve, whereby on the basis of switching action by the dynamic pressure switching valve, pressure in the working air chamber can be dynamically modified.
